(19) United States
(12) Patent Application Publication
(10) Pub. No.: US 2026/0154581 A1
(43) Pub. Date: Jun. 4, 2026

(54) SYSTEM AND METHOD FOR EVALUATING ARTIFICIAL INTELLIGENCE AGENTS

(71) Applicant: Quantiphi, Inc., Marlborough, MA (US)

(72) Inventors: Dagnachew Birru, Marlborough, MA (US); Sushant Desale, Mumbai (IN); Akanksha Upadhyaya, Mumbai (IN); Zishan Ahmad, Mumbai (IN); Vishal Vaddina, Toronto, Ontario (CA)

(21) Appl. No.: 19/451,772

(22) Filed: Jan. 16, 2026

(51) Int. Cl. G06N 5/043

(52) U.S. Cl. CPC G06N 5/043

(57) ABSTRACT

A method and system for evaluating Artificial Intelligence (AI) agents is disclosed. The method includes receiving a profile of the AI agent. The method may further include generating synthetic data based on the received profile of the AI agent. The method may further include interacting with the AI agent to generate traces when the AI agent is interactive. Further, the method includes generating an evaluation score based on the traces of the AI agent with respect to a corresponding evaluation metric by a plurality of evaluator agents. The method further includes generating an evaluation report by consolidating the evaluation scores of each of the plurality of evaluator agents.

### FIELD OF THE INVENTION

The present disclosure relates to Artificial Intelligence (AI), and more specifically to a system and method for evaluating the AI agents.

### BACKGROUND OF THE INVENTION

Artificial intelligence (AI) agents and multi-agent systems are increasingly being deployed across diverse domains, including healthcare, finance, customer service, and autonomous decision-making. The AI agents are designed to execute complex tasks, often involving multiple steps, tool usage, or decision chains. As such systems become more sophisticated, reliable evaluation of their performance has become a critical requirement for developers, enterprises, and regulatory bodies.

Conventionally, the evaluation of the AI agents relies heavily on ground truth data. A predefined set of labelled inputs and outputs is used to assess whether the AI agent produces correct results. While effective in certain applications, the conventional method encounters significant challenges. Ground truth data is often expensive to curate, time-consuming to annotate, and in many cases entirely unavailable, particularly in emerging or specialized domains. The absence of such data makes it difficult to validate the accuracy and robustness of agents at scale.

Another limitation of existing evaluation approaches is the focus on outcome-level assessment. Most frameworks measure only the final output of the AI agent without considering the intermediate reasoning steps, tool calls, or decision-making processes that lead to the outcome, creating a diagnostic gap, as developers are unable to identify why an agent succeeded or failed in a given task. The lack of process-level evaluation hampers the ability to pinpoint specific weaknesses or areas requiring improvement. Unlike non-interactive agents that produce outputs in response to a single input, interactive agents operate in multi-turn environments, engaging in iterative exchanges with users or external systems. Conventional evaluation methods provide limited support for such dynamic interactions. Existing frameworks often fail to simulate realistic environments or conversations, making it difficult to rigorously test the adaptability and resilience of interactive AI agents under varying conditions.

Furthermore, conventional methods do not adequately address the scalability and automation required for evaluating large numbers of agents or multi-agent systems. Manual creation of datasets and ad-hoc evaluation setups lead to inefficiencies, inconsistent results, and restricted applicability across domains. There is also a lack of mechanisms for comparing multiple evaluation metrics in a unified manner, limiting the ability to obtain a holistic view of an agent's performance.

Therefore, there exists a need for improved techniques for evaluating AI agents and multi-agent systems that can overcome the reliance on ground truth data, enable process-level diagnostics, support interactive environments, and provide scalable, automated, and comprehensive evaluation capabilities.

### SUMMARY

The following embodiments presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide computer-implemented method for evaluating Artificial Intelligence (AI) agents, the method may include receiving a profile of the AI agent. The method may further include generating synthetic data based on the received profile of the AI agent. The method may further include interacting with the AI agent to generate traces when the AI agent is interactive and obtaining output when the AI agent is non-interactive. The method may further include generating an evaluation score based on the traces of the AI agent with respect to a corresponding evaluation metric by a plurality of evaluator agents. Further, the method may include generating an evaluation report by consolidating the evaluation scores of each of the plurality of evaluator agents. In some embodiments, the method may include evaluating the AI agents on one or more test samples provided by a user.

According to some example embodiments, the profile of the AI agent includes one or more of a purpose of the AI agent, a domain of operation, a workflow description, and a set of tools accessible to the AI agent. In some embodiments, the profile of the AI agent may include high overview of the system, root agent/orchestrator, a gent tool and Tools description, Hierarchical Representation Of Agentic Setup and Overall Workflow Summary. Further, the profile of the AI agents may also contain sub-agent descriptions.

According to some example embodiments, generating synthetic data based on the received profile of the AI agent, the method includes generating a plurality of test scenarios and task completion criteria based on the profile of the AI agent. Further, the method includes generating synthetic data for the plurality of generated test scenarios.

According to some example embodiments, the method includes executing the AI agent to generate the traces based on the generated synthetic data, when the AI agent is not interactive.

According to some example embodiments, interacting with the AI agent to generate traces, the method includes planning an interaction sequence with the AI agent based on the plurality of test scenarios. Further, the method includes executing the interaction sequence with the AI agent to generate the traces.

According to some example embodiments, generating an evaluation score based on the traces of the AI agent, the method includes evaluating reasoning accuracy, tool-calling efficiency, and outcome accuracy of the AI agent.

According to some example embodiments, generating an evaluation report, the method further includes computing correlations among evaluation metric and the evaluation scores.

Some example embodiments disclosed herein provide a system for evaluating Artificial Intelligence (AI) agents. The system includes a data generation module configured to generate synthetic data based on a profile of the AI agent. Further, the system includes a simulation module configured to interact with the AI agent to generate traces when the AI agent is interactive, and obtaining output when the AI agent is non-interactive. The system further includes an evaluator module including a plurality of evaluator agents. Each of the plurality of evaluator agents is configured to generate an evaluation score based on the traces of the AI agent with respect to a corresponding evaluation metric. Further, the system may include a report aggregation module configured to consolidate the evaluation scores of each of the plurality of evaluator agents to generate an evaluation report.

Some example embodiments disclosed herein provide a non-transitory computer readable medium having stored thereon computer executable instruction which when executed by one or more processors, cause the one or more processors to carry out operations for evaluating Artificial Intelligence (AI) agents, the operations receiving a profile of the AI agent. The profile of the AI agent includes one or more of a purpose of the AI agent, a domain of operation, a workflow description, and a set of tools accessible to the AI agent. Further, the operations includes generating synthetic data based on the received profile of the AI agent. Further, the operations includes interacting with the AI agent to generate traces when the AI agent is interactive. The operation may include generating an evaluation score based on the traces of the AI agent with respect to a corresponding evaluation metric by a plurality of evaluator agents. Further, the operations may include generating an evaluation report by consolidating the evaluation scores of each of the plurality of evaluator agents.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present invention will become apparent upon consideration of the following detailed description of embodiments thereof, especially when taken in conjunction with the accompanying drawings, and wherein:

FIG. 1 is a block diagram of an environment of a system for evaluating Artificial Intelligence (AI) agents, in accordance with an example embodiment.

FIG. 2 illustrates a block diagram of a data generation module of a computing device configured to generate synthetic data, in accordance with an example embodiment.

FIG. 3 illustrates a block diagram of a simulation module of the computing device configured to interact with the AI agent to generate traces, in accordance with an example embodiment.

FIG. 4 illustrates a block diagram of an evaluator module and a report aggregation module of the computing device configured to generate an evaluation report, in accordance with an example embodiment.

FIG. 5 illustrates a flow diagram of a method for evaluating AI agents, in accordance with an example embodiment.

FIG. 6 illustrates a method for evaluating the AI agents, in accordance with an example embodiment.

FIG. 7 illustrates a block diagram of an exemplary computer system for implementing embodiments consistent with the present disclosure.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present invention. It will be apparent, however, to one skilled in the art that the present invention can be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises... a” does not, without more constraints, preclude the existence of other elements or additional elements in the system or method.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “Artificial Intelligence (AI) agents” may refer to a process of allocating employees to specific shifts or tasks within one or more units, considering skills, workload requirements, preferences, and operational constraints.
The term “Ground truth data” may refer to a verified dataset that represents the most accurate and reliable reference against which the performance of an AI agent or system may be evaluated. The ground truth data typically includes pre-labelled inputs and corresponding expected outputs, collected either through human annotation, direct observation, or authoritative sources. The ground truth data serves as the benchmark to measure correctness, accuracy, or reliability of an agent's predictions, decisions, or actions.
The term “non-interactive agents” may be used to refer to a class of AI agents that operate in a one-shot or single-pass manner, where the input is provided to the AI agent and a corresponding output is generated without requiring back-and-forth exchanges with a user or environment. The non-interactive agents follow a predefined workflow to transform input into output and are evaluated based on accuracy or correctness of the final result against ground truth or synthetic datasets.
The term “Interactive agents” may refer to the AI agents that perform tasks through multi-turn interactions with the user, system, or environment. The interactive agents rely on iterative decision-making and feedback loops, often adapting the behaviour or strategy based on intermediate responses, policies, or contextual changes.
The term “Trace” may refer to a structured record of the AI agent's execution process, capturing input-output pairs, intermediate reasoning steps, tool calls, and decisions made during task execution.
The term “module” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

### End of Definitions

As described earlier, the present disclosure relates generally to evaluation of Artificial Intelligence (AI) agents, and more particularly, to automated frameworks for workload-agnostic, data-independent, and process-level evaluation of single-agent and multi-agent systems. Conventional evaluation techniques primarily rely on availability of ground truth data and focus only on outcome accuracy. Such approaches are insufficient for diagnosing process-level errors (e.g., flawed reasoning, incorrect tool calls, or intermediate failures), especially for interactive agents that require continuous feedback and dynamic adaptation. Further, the conventional methods treat evaluation as a static, outcome-based exercise and may not provide modular, automated mechanisms to test the AI agents in new domains lacking labelled datasets. The shortcomings may lead to unreliable performance benchmarking, higher development costs, reduced adaptability in novel domains, and a lack of actionable insights for the AI agent improvement.

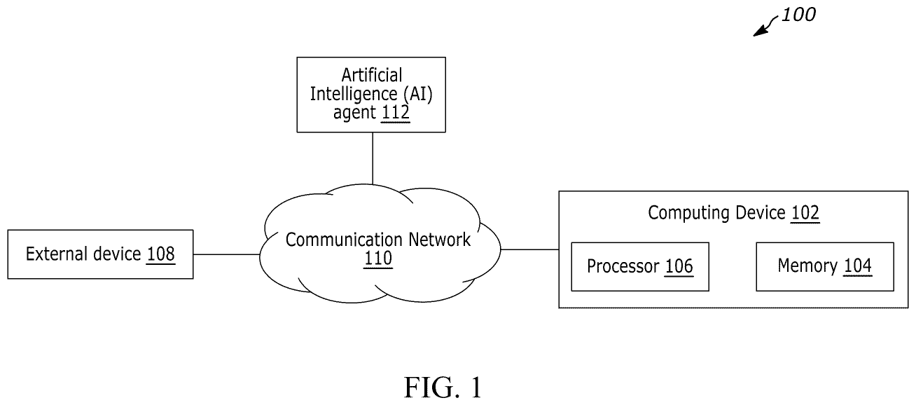

The present disclosure provides a system and method for automated, multi-metric evaluation of the AI agents and multi-agent systems through synthetic data generation, simulation-based interaction, and process-level diagnostic analysis. The present disclosure integrates a synthetic data generation agent, a simulation agent, an evaluator swarm, and a report aggregation module orchestrated through modular intelligent AI agents. The synthetic data generation agent creates high-fidelity datasets for non-interactive AI agents in the absence of ground truth data. The simulation agent creates dynamic, multi-turn interaction scenarios for interactive agents, adapting in real time to agent responses. The evaluator swarm includes specialized evaluator AI agents that analyse reasoning quality, tool-calling efficiency, decision correctness, and outcome validity across the agent's execution trace. The report aggregation agent synthesizes evaluator outputs, validates metric relevance through correlation with outcomes, and generates consolidated diagnostic reports highlighting strengths, weaknesses, and optimization recommendations. The present disclosure may be implemented using multiple AI/ML techniques, including scenario-based generation models, planner-interaction frameworks, and optimization methods such as correlation-based metric validation. The disclosed framework ensures rigorous evaluation in domains where labelled datasets are unavailable, provides actionable process-level diagnostics, reduces manual effort, and enhances reliability and adaptability of agentic systems. Embodiments of the present disclosure may provide a method, a system, and a computer program product for agent evaluation that is scalable, explainable, and domain-agnostic. The method, the system, and the computer program product evaluate the AI agents in such an improved manner are described with reference to FIG. 1 to FIG. 7 as detailed below.

FIG. 1 illustrates a block diagram of an environment of a system 100 for evaluating Artificial Intelligence (AI) agents 112, in accordance with an example embodiment. The system 100 includes a computing device 102, an external device 108, a communication network 110, and the AI agent 112. The computing device 102 may be communicatively coupled with the external device 108 via the communication network 110. Examples of the computing device 102 may include, but are not limited to, a server, a desktop, a laptop, a notebook, a tablet, a smartphone, a mobile phone, an application server, a cloud computing architecture, or the like.

The communication network 110 may be wired, wireless, or any combination of wired and wireless communication networks, such as cellular, Wi-Fi, internet, local area networks, or the like. In one embodiment, the communication network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including Enhanced Data Rates or Global Evolution (EDGE), General Packet Radio Service (GPRS), Global System for Mobile Communications (GSM), Internet Protocol Multimedia Subsystem (IMS), Universal Mobile Telecommunications System (UMTS), etc., as well as any other suitable wireless medium, e.g., Worldwide Interoperability for Microwave Access (WiMAX), Long Term Evolution (LTE) networks, Code Division Multiple Access (CDMA), Wideband Code Division Multiple Access (WCDMA), Wireless Fidelity (Wi-Fi), Wireless LAN (WLAN), Bluetooth®, Internet Protocol (IP) data casting, satellite, Mobile Ad-Hoc Network (MANET), and the like, or any combination thereof.

The computing device 102 may include a memory 104, and a processor 106. The term “memory” used herein may refer to any computer-readable storage medium, for example, volatile memory, Random Access Memory (RAM), non-volatile memory, Read Only Memory (ROM), or flash memory. The memory 104 may include a Random-Access Memory (RAM), a Read-Only Memory (ROM), a Complementary Metal Oxide Semiconductor Memory (CMOS), a magnetic surface memory, a Hard Disk Drive (HDD), a floppy disk, a magnetic tape, a disc (CD-ROM, DVD-ROM, etc.), a USB Flash Drive (UFD), or the like, or any combination thereof.

The term “processor” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The processor 106 may retrieve computer program code instructions that may be stored in the memory 104 for execution of the computer program code instructions. The processor 106 may be embodied in a number of different ways. For example, the processor 106 may be embodied as one or more of various hardware processing means such as a coprocessor, a microprocessor, a controller, a Digital Signal Processor (DSP), a processing element with or without an accompanying DSP, or various other processing circuitry including integrated circuits such as, for example, an Application Specific Integrated Circuit (ASIC), an Field Programmable Gate Array (FPGA), a Microcontroller Unit (MCU), a hardware accelerator, a special-purpose computer chip, or the like. As such, in some embodiments, the processor 106 may include one or more processing cores configured to perform independently. A multi-core processor may enable multiprocessing within a single physical package. Additionally, or alternatively, the processor 106 may include one or more processors configured in tandem via the bus to enable independent execution of instructions, pipelining, and/or multithreading.

Additionally, or alternatively, the processor 106 may include one or more processors capable of processing large volumes of workloads and operations to provide support for big data analysis. In an example embodiment, the processor 106 may be in communication with a memory 104 via a bus for passing information among components of the system 100.

The memory 104 may be non-transitory and may include, for example, one or more volatile and/or non-volatile memories. In other words, for example, the memory 104 may be an electronic storage device (for example, a computer readable storage medium) comprising gates configured to store data (for example, bits) that may be retrievable by a machine (for example, a computing device like the processor 106). The memory 104 may be configured to store information, data, contents, applications, instructions, or the like, for enabling the apparatus to carry out various functions in accordance with an example embodiment of the present disclosure. For example, the memory 104 may be configured to buffer input data for processing by the processor 106.

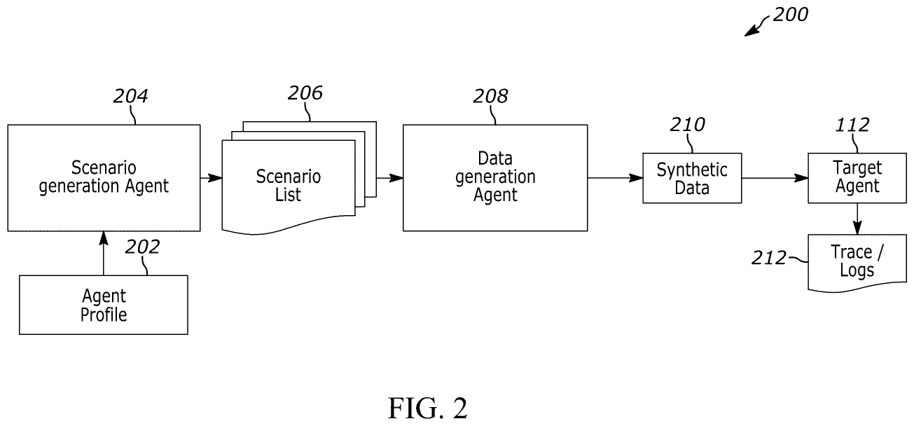

The computing device 102 may be capable of evaluating Artificial Intelligence (AI) agents. The memory 104 may store instructions that, when executed by the processor 106, cause the computing device 102 to perform one or more operations of the present disclosure which will be described in greater detail in conjunction with FIGS. 2 to 7. The computing device 102 may include a data generation module configured to generate synthetic data based on a profile of the AI agent 112. Further, the computing device 102 may include a simulation module configured to interact with the AI agent 112 to generate traces, when the AI agent 112 is interactive, and obtaining output when the AI agent is non-interactive. In some embodiments, the method may include evaluating the AI agents on one or more test samples provided by a user. The computing device 102 may include evaluator module including a plurality of evaluator agents. Each of the plurality of evaluator agents is configured to generate an evaluation score based on the traces of the AI agent 112 with respect to a corresponding evaluation metric. The computing device 102 may further include a report aggregation module configured to consolidate the evaluation scores of each of the plurality of evaluator agents to generate an evaluation report.

In an embodiment, the AI agent 112 may be a computational entity configured to perform one or more tasks by perceiving inputs, reasoning over intermediate states, and producing outputs in accordance with a defined goal or workflow. The AI agent 112 may operate independently or as part of a multi-agent system. The AI agent 112 may utilize tools, models, or external services, and may perform tasks in a single step (non-interactive) or through multiple iterative exchanges with users or environments (interactive). In certain embodiments, the AI agent 112 may be a non-interactive agent that generates an output in response to a single input without requiring further feedback. In such embodiments, evaluation may be performed using synthetic data generated from the profile of the AI agent 112. In other embodiments, the AI agent 112 may be an interactive agent that engages in multi-turn interactions with a user or environment. In such embodiments, evaluation may be performed through a simulation process in which a planner agent and an interaction agent generate dynamic conversations or scenarios. In yet other embodiments, the AI agent 112 may be configured for domain-specific tasks, such as medical diagnosis, financial transaction analysis, legal document review, or enterprise workflow automation. The framework may evaluate such agents irrespective of the availability of ground truth data.

The external devices 108 may refers to various hardware and software tools that may be integrated with the system 100 to enhance its functionality. The complete process followed by the system 100 is explained in detail in conjunction with FIG. 1 to FIG. 7.

FIG. 2 illustrates a block diagram 200 of the data generation module of the computing device 102 configured to generate synthetic data, in accordance with an example embodiment. The data generation module operates when ground truth data is unavailable and enables systematic testing of both non-interactive and multi-step AI agents 112 by creating representative input-output datasets.

In an embodiment, the profile 202 of the AI agent 112 is provided as an input to the scenario generation agent 204. The profile 202 of the AI agent 112 may include information related to the AI agent's 112 operational domain, workflow, available tools, and decision-making logic. The profile 202 of the AI agent 112 is utilized as a basis for creating test scenarios that accurately reflect the conditions under which the target AI agent 112 operates. The scenario generation agent 204 is configured to analyse the workflow and tool details of the target agent 112 and to derive a scenario list 206. The scenario list 206 may include a plurality of test scenarios, each designed to invoke specific tool calls, decisions, and expected outcomes. The scenarios may be defined so as to cover diverse permutations and combinations of tasks that the agent is expected to encounter in practice. In an example, a travel booking agent's scenario list may include booking a flight, handling a cancellation, or changing travel dates. By covering varied workflows, the scenario list ensures comprehensive and realistic evaluation of agent performance.

The scenario list 206 is then provided to a data generation agent 208. The data generation agent 208 is configured to transform each scenario into a set of synthetic data 210. In one embodiment, the data generation agent 208 may produce input-output pairs aligned with the expected operations of the target agent 112. The synthetic data 210 is designed to stimulate the AI agent's 112 decision-making process in a manner consistent with the scenario definitions, ensuring that tool calls and reasoning steps are appropriately exercised. The generated synthetic data 210 is subsequently fed to the target AI agent 112. The target AI agent 112 executes its internal workflow on the provided synthetic data 210 and generates outputs. During the execution, the system 100 captures detailed traces and logs 212 of the AI agent's 112 behaviour. The traces 212 may include, for example, intermediate reasoning steps, tool invocation records, and final outputs generated by the AI agent 112. The data generation module enables automated creation of test data and corresponding execution traces 212 without reliance on ground truth datasets. The traces 212 produced by the target AI agent 112 form the basis for further evaluation by one or more evaluator agents, as described in other embodiments of the present disclosure.

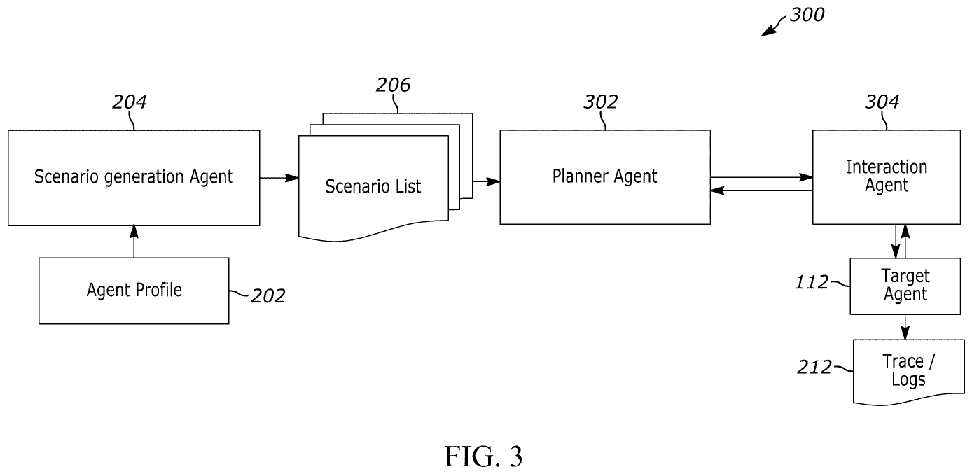

FIG. 3 illustrates a block diagram 300 of the simulation module of the computing device 102 configured to interact with the AI agent 112 to generate traces 212, in accordance with an example embodiment. The simulation module is particularly applicable for the evaluation of interactive agents, where multi-turn exchanges between the AI agent 112 and an environment or user are required. The scenario generation agent 204 receives the agent profile (profile of the AI agent) 202 as input. The agent profile 202 may include information defining the characteristics of the AI agent 112 to be evaluated, including the operational purpose, domain of application, tool usage, workflows, and policies governing decision-making.

The scenario generation agent 204 is configured to analyse the workflow and policies of the target agent 112 to derive the scenario list 206. Each scenario in the scenario list 206 may represent a sequence of conditions, tool calls, and decisions that are expected to invoke the AI agent's 112 reasoning process during evaluation. The scenarios may be designed to cover a wide range of possible interaction paths, ensuring comprehensive testing. Further, a planner agent 302 is connected to the scenario generation agent 204 and receives the scenario list 206 as input. The planner agent 302 is configured to plan multi-step interactions with the target agent 112 based on the scenarios. The planner agent 302 considers the agent profile 202, possible tool calls, expected decision points, and desired outcomes. In certain embodiments, the planner agent 302 may dynamically adjust the interaction flow in real time based on the responses received from the target agent 112.

In an embodiment, an interaction agent 304 is communicatively coupled with the planner agent 302. The interaction agent 304 is configured to execute the planned interactions by directly engaging with the target agent 112. In one embodiment, the interaction agent 304 may simulate a user or an external environment, provide inputs, and receive outputs in a conversational or iterative manner. The interaction agent 304 also provides the responses of the target agent 112 back to the planner agent 302, enabling adaptive refinement of subsequent interactions. Further, the target agent 112 processes the inputs from the interaction agent 304 and produces outputs in accordance with its internal workflow. During the process, the system 100 generates and stores traces and logs 212. The traces 212 may include detailed records of the AI agent's 112 operations, including intermediate decisions, reasoning steps, tool invocations, and final outputs. The simulation module enables the automated generation of realistic multi-turn interactions with the target agent 112, allowing for the capture of detailed traces 212 in the absence of pre-existing ground truth datasets. The traces 212 may subsequently be analysed by evaluator agents to assess the performance of the target agent 112 at both process and outcome levels.

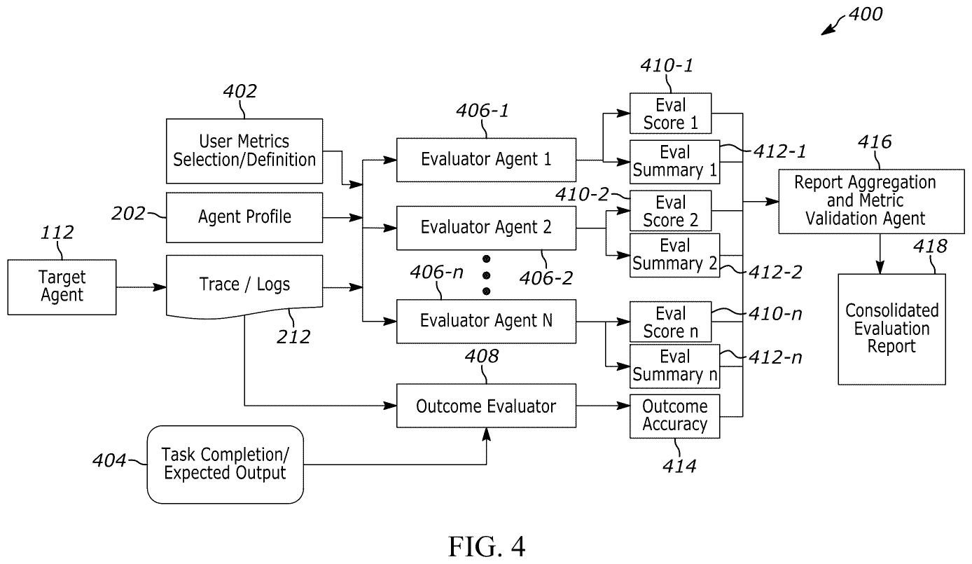

FIG. 4 illustrates a block diagram 400 of the evaluator module and the report aggregation module of the computing device 102 configured to generate an evaluation report, in accordance with an example embodiment. The evaluator module is responsible for analysing the performance of the target agent 112 based on execution traces 212, selected metrics, and expected outcomes, while the report aggregation module synthesizes the evaluation results into a consolidated output.

In an embodiment, the target AI agent 112 produces traces/logs 212 during execution as explained in detail in FIGS. 2 and 3. The traces 212 capture detailed records of the AI agent's 112 operation, including intermediate reasoning steps, tool calls, decision points, and final outputs. The traces 212 serve as the primary input for the evaluator module. The evaluator module is also provided with one or more user-defined or pre-configured metrics 402. The evaluator module enables customization of evaluation criteria by allowing users to select from existing metrics or define new metrics based on the AI agent's 112 operational context. In addition, the AI agent profile 202 may be supplied to provide further contextual information regarding the purpose, workflow, and tool usage of the target agent 112. The evaluator module may include an evaluator agents 1 406-1, evaluator agents 2 406-2, . . . , and evaluator agents N 406-n (commutatively referred as the evaluator agent or an evaluator agent swarm 406), each of the evaluator agent 406 is configured to assess the target agent's 112 performance against a corresponding metric. For example, the evaluator agents 406 may be configured to assess reasoning accuracy, tool invocation efficiency, or decision-making coherence. Each evaluator agent 406 produces an evaluation score 410 and an evaluation summary 412, providing both quantitative and qualitative feedback for the target agent 112. The evaluation score 410 may be a numerical measure that reflects how well the target agent 112 performed against a defined metric, such as reasoning quality, tool usage accuracy, or outcome correctness. Further, the evaluation summary 412 complements the evaluation score 410 by providing a descriptive explanation of the agent's behaviour during the task.

The evaluator module further includes an outcome evaluator 408. The outcome evaluator 408 compares the final outputs of the target agent 112 with expected outputs or task completion criteria 404. Based on the comparison, the outcome evaluator 408 produces an outcome accuracy score 414, which represents the correctness of the target agent's 112 results at the task level. The results generated by the evaluator agents 406 and the outcome evaluator 408 are subsequently provided to a report aggregation and metric validation agent 416. The report aggregation and metric validation agent 416 is configured to perform correlation analysis across the evaluation metrics 410/412 and outcome scores 414 to determine the relative importance, reliability, and redundancy of the metrics. In certain embodiments, the metric validation agent 416 eliminates redundant metrics and highlights the most informative metrics for understanding the AI agent's 112 performance. The metric validation agent 416 may be responsible for analysing all the evaluation score 410 generated by the evaluator agents 406 to ensure the evaluation scores 410 are meaningful and non-redundant. In an embodiment, the metric validation agent 416 may compare the correlation between different evaluation scores 410 and the overall outcome accuracy to identify which evaluation score 410 truly reflect the target agent 112's performance. By doing so, the metric validation agent 416 identifies the overlapping or less useful measures and highlights the most informative ones, ensuring that the evaluation focuses on metrics that provide clear, reliable, and actionable insights into the AI agent's 112 strengths and weaknesses.

In an embodiment, the report aggregation and metric validation agent 416 generates a consolidated evaluation report 418. The consolidated evaluation report 418 integrates the evaluation scores 410, evaluation summaries 412, outcome accuracy 414, and metric relevance analysis into a structured output. The consolidated evaluation report 418 may include, for example, a list of the AI agent's 112 strengths and weaknesses, an assessment of overall performance, and recommendations for improvement. The evaluator module and the report aggregation module collectively enable comprehensive analysis of the target agent 112 at both process-level and outcome-level granularity, ensuring that evaluation results are presented in a unified, actionable format.

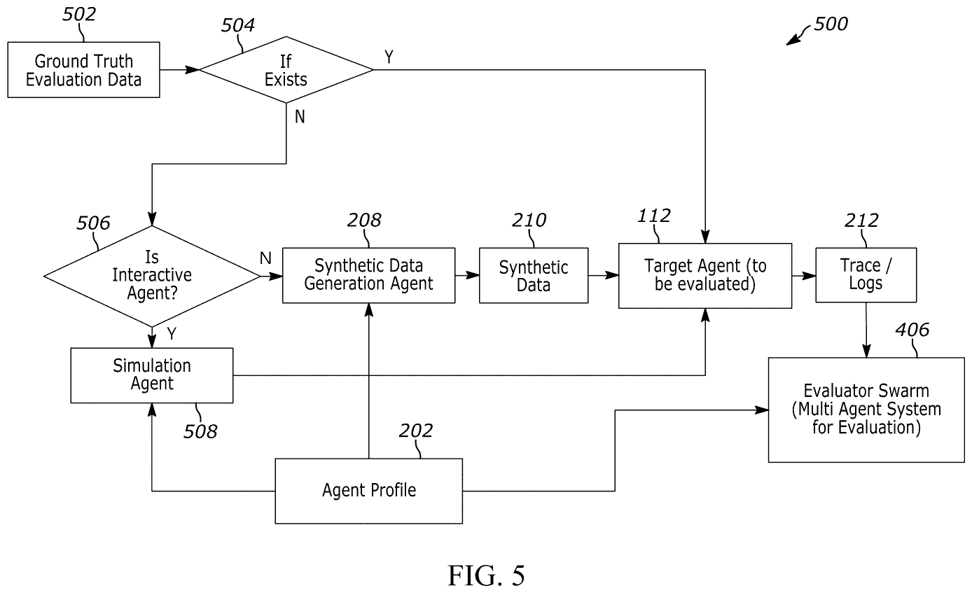

FIG. 5 illustrates a flow diagram 500 of a method for evaluating the AI agents 112, in accordance with an example embodiment. The method provides a unified evaluation framework that operates with or without the availability of ground truth data 502 and adapts to both interactive and non-interactive AI agents 112.

The method begins by determining whether ground truth evaluation data 502 exists. When such ground truth data 502 is available, the evaluation may proceed directly by applying the ground truth data to a target agent 112 and obtaining execution traces 212 and outputs. The traces 212 may then be analysed by the evaluator swarm 406, as explained in detail in FIG. 4.

When ground truth data is not available, the method proceeds to determine whether the target AI agent 112 is an interactive agent. If the AI agent 112 is identified as non-interactive, the synthetic data generation agent 208 is invoked. The synthetic data generation agent 208 utilizes an agent profile 202 to create a set of synthetic data 210 that replicates realistic input-output conditions for the target AI agent 112. The synthetic data 210 is provided to the target agent 112, and the resulting execution traces 212 and outputs are collected for evaluation.

Further, if the target agent 112 is determined to be interactive, the method invokes the simulation agent 508. The simulation agent 508 is configured to generate and manage multi-turn interactions with the target agent 112. The simulation process uses the agent profile 202 to design scenarios that incorporate workflows, tools, and policies expected to be triggered during real-world operation. The simulation agent 508 supplies input exchanges to the target agent 112 and records the resulting responses, generating execution traces 212 for further analysis, as explained in detail in FIG. 4. Regardless of whether ground truth data 502, synthetic data 210, or simulated interactions are used, the target AI agent 112 produces outputs and associated traces/logs 212 during evaluation. The traces 212 include intermediate reasoning steps, tool calls, decision outcomes, and final outputs.

The traces 212 are then analysed by the evaluator swarm 406. The evaluator swarm 406 may include a plurality of evaluator agents, each configured to assess specific aspects of the target agent's 112 performance. For example, evaluator agents may measure reasoning accuracy, tool invocation efficiency, decision-making quality, or overall outcome accuracy. The evaluator swarm 406 enables multi-dimensional evaluation of the target agent's 112 performance. The method enables comprehensive evaluation of AI agents 112 irrespective of the availability of ground truth data 502 or the type of target agent 112 being evaluated. The adaptive use of synthetic data generation or simulation ensures that both interactive and non-interactive AI agents 112 may be tested in a systematic and automated manner, with results analysed by a multi-agent evaluation system.

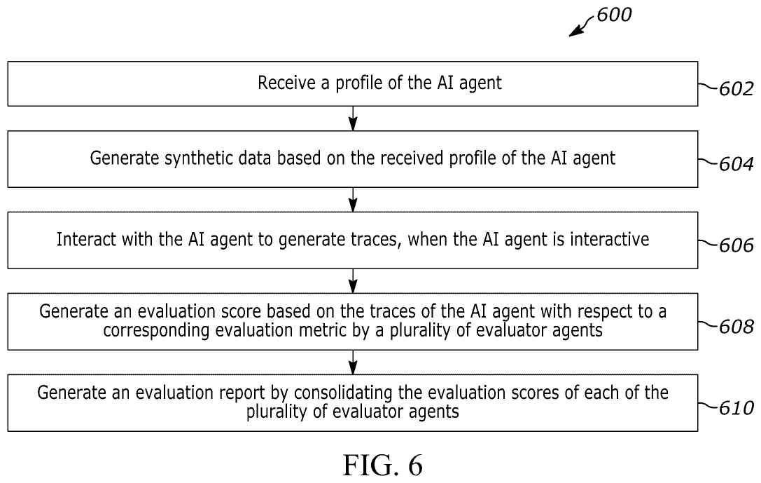

FIG. 6 illustrates a method 600 for evaluating the AI agents 112, in accordance with an example embodiment. The method 600 may be implemented by one or more processors executing computer-readable instructions stored in a memory of the computing device 102.

At step 602, a profile of the AI agent is received. The profile of the AI agent may include information related to the AI agent's purpose, operational domain, workflow, policies, and tools available for task execution. The profile of the AI agent may serve as the foundation for generating appropriate test scenarios and evaluation conditions. In some embodiments, the profile of the AI agent may include high overview of the system, root agent/orchestrator, agent tool and Tools description, Hierarchical Representation Of Agentic Setup and Overall Workflow Summary. Further, the profile of the AI agents may also contain sub-agent descriptions.

At step 604, synthetic data is generated based on the received profile of the AI agent. Further, a plurality of test scenarios and task completion criteria are generated based on the profile of the AI agent and synthetic data for the plurality of generated test scenarios. When ground truth data is unavailable, the synthetic data is created to emulate realistic inputs and expected outputs. The synthetic data is related to the test scenarios in a way depicting the constraints and features of the test scenarios. The synthetic data is designed to stimulate the AI agent's reasoning process, tool usage, and decision-making chain, producing representative traces for evaluation of the AI agents.

At step 606, the simulation agent interacts with the AI agent to generate the traces, when the AI agent is interactive, and obtaining output when the AI agent is non-interactive. The simulation agent executes the AI agents to generate the traces based on the generated synthetic data when the AI agent is not interactive. In certain embodiments, the simulation agent interacts with the AI agent in a multi-turn exchange, simulating user behaviour or environmental responses. The interaction produces execution traces comprising intermediate decisions, reasoning steps, tool calls, and outputs. In an embodiment, the simulation agent may plan an interaction sequence with the AI agent based on the plurality of test scenarios. Further, the simulation agent may execute the interaction sequence with the AI agent to generate the traces.

At step 608, an evaluation score is generated based on the traces of the AI agent with respect to a corresponding evaluation metric by a plurality of evaluator agents. The evaluation score is generated by evaluating the reasoning accuracy, tool-calling efficiency, and outcome accuracy of the AI agent. Each evaluator agent produces an evaluation score and a corresponding summary describing the observed performance. In some embodiments, the method may include evaluating the AI agents on one or more test samples provided by a user.

At step 610, an evaluation report is generated by consolidating the evaluation scores of each of the plurality of evaluator agents. The report aggregation agent may compute the correlations among evaluation metric and the evaluation scores to generate the evaluation report. In one embodiment, the report aggregation agent synthesizes the evaluation scores and summaries into a comprehensive report. The evaluation report may identify strengths and weaknesses of the AI agent, validate metric relevance through correlation analysis, and provide recommendations for improving performance.

In an embodiment, a challenge is to create data that is not just random but actually test the AI agent's logic and tool usage thoroughly. This may be solved by creating a dedicated scenario generation agent that first outlines complex test scenarios, which a data generation agent then uses as a blueprint to create targeted, high-fidelity input data. For interactive agents, static test cases are inadequate. The solution is a planner-interaction agent pair. The planner agent creates a dynamic plan based on a scenario, and the interaction agent executes it, feeding the target agent's responses back to the planner to allow for real-time plan adjustments, creating a living, responsive simulation. A modular system of specialized evaluator agents. Each agent focuses on a specific performance metric (like tool calls or decision-making), providing a granular, diagnostic summary. The report aggregator agent then synthesizes the individual evaluations into a single, comprehensive report. The framework analyzed the correlation of individuals and combined metric scores against the final outcome and ground truth data. The method allow to identify which metrics (or combinations of metrics) are the most reliable indicators of overall agent performance, enabling refinement of the evaluation process and providing more relevant metric recommendations to the user.

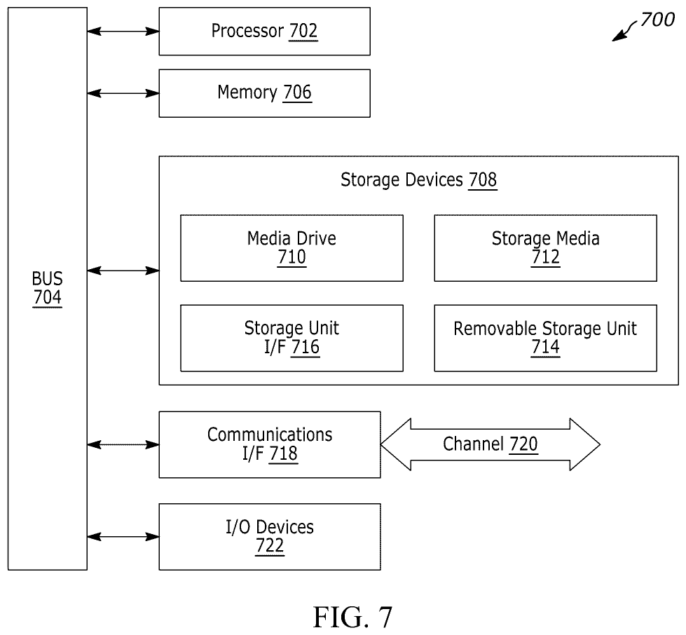

The disclosed methods and systems may be executed on a conventional or general-purpose computing system, such as a personal computer (PC) or server. Referring to FIG. 7, an exemplary computing system 700 is illustrated, which may implement processing functionality for various embodiments (e.g., as a SIMD device, client device, server device, or one or more processors). Those skilled in the art will recognize that other computing systems or architectures may also be used to implement the invention. The computing system 700 may represent a user device, such as a desktop, laptop, mobile phone, personal entertainment device, DVR, or any other special or general-purpose computing device appropriate for a given application or environment. The computing system 700 may include one or more processors, such as processor 702, implemented using a general-purpose or specialized processing engine, such as a microprocessor, microcontroller, or other control logic. In some embodiments, processor 702 may be an AI processor, implemented as a Tensor Processing Unit (TPU), graphical processing unit (GPU), or custom-programmable solution, such as a Field-Programmable Gate Array (FPGA).

The computing system 700 may further include memory 706 (e.g., Random Access Memory (RAM) or other dynamic memory) for storing instructions and information to be executed by processor 702. Memory 706 may also store temporary variables or intermediate information during execution. Additionally, the computing system 700 may include a read-only memory (ROM) or other static storage device connected to bus 704 for storing static information and instructions for processor 702.

Storage devices 708 may also be included in computing system 700, consisting of, for example, a media drive 710 and a removable storage interface. Media drive 710 may support fixed or removable storage media, such as hard disk drives, floppy drives, magnetic tape drives, SD card ports, USB ports, optical disk drives (e.g., CD or DVD drives), or other media. Storage media 712 may include hard disks, magnetic tapes, flash drives, or other media that can be read and written to by media drive 710. Storage media 712 may store computer-readable software or data.

Alternatively, storage devices 708 may include other means for loading computer programs or data into computing system 700, such as removable storage unit 714 and interface 716, program cartridges, removable memory (e.g., flash memory), memory slots, and similar storage units and interfaces.

Computing system 700 may also include a communications interface 718 to transfer software and data between external devices 112 and system 700. Examples include network interfaces (e.g., Ethernet), communication ports (e.g., USB, micro-USB), Near Field Communication (NFC), and other protocols. The signals transferred via communications interface 718 may include electronic, electromagnetic, optical, or other forms of transmission through channel 720, which may utilize wireless mediums, fibre optics, wires, or cables.

Computing system 700 may also include Input/Output (I/O) devices 722, such as a display, keypad, microphone, speakers, vibration motors, LED indicators, etc., allowing user interaction and feedback. The term “computer-readable medium” may refer to any storage medium used, such as memory 706, storage devices 708, removable storage unit 714, or signal(s) on channel 720. Such media may store sequences of instructions, or “computer program code,” which, when executed, enable computing system 700 to perform the methods and functions described in embodiments of the invention.

In embodiments where elements are implemented in software, the software may be stored on a computer-readable medium and loaded into computing system 700 via removable storage unit 714, media drive 710, or communications interface 718. When executed by processor 702, this control logic (e.g., software instructions or computer program code) causes processor 702 to perform the invention's functions as described.

As will be appreciated by those skilled in the art, the techniques described in the various embodiments discussed above are not routine, or conventional, or well understood in the art. The techniques discussed above provide for innovative solutions to address the challenges associated with evaluating the AI agents 112. The disclosed techniques offer several advantages over the existing methods:
Enhanced diagnostic accuracy: Unlike conventional outcome-only evaluations approaches, the present disclosure pinpoints the exact cause of failure such as, flawed reasoning, incorrect tool call, or suboptimal decision by analysing the target agent's full execution trace;
Increased efficiency: By automating scenario generation, synthetic data creation, simulation, and reporting, the framework drastically reduces the manual effort and time required for evaluating the AI agents;
Improved adaptability: The present disclosure evaluate the AI agents even in novel domains where labelled ground truth data is scarce or absent, supporting faster development across industries;
Automated, Actionable reporting: the report aggregation and metric validation module synthesizes evaluator outputs into a consolidated report that highlights strengths, weaknesses, and relevant metrics, ensuring developers receive clear and prioritized feedback; and
Dynamic Simulation for Interactive Agents: The planner-interaction agent pair creates real-time, adaptive simulations, making it possible to test agents in dynamic environments that mimic real-world interaction patterns.

The disclosed techniques offer several applications including:
Conversational AI Systems: Evaluation of chatbots, customer service agents, and virtual assistants in multi-turn dialogue settings to ensure accurate reasoning, policy adherence, and user satisfaction;
Enterprise workflow automation: Assessment of non-interactive task automation agents, such as document processors or scheduling bots, where synthetic data can validate correctness without costly labelled datasets;
Healthcare diagnostics: Evaluation of clinical decision support agents, medical diagnostic tools, or symptom triage systems by simulating patient interactions and testing reasoning pathways against standard protocols;
Financial and transactional Systems: Testing of fraud detection agents, transaction monitoring bots, or advisory systems where outcome accuracy and reasoning transparency are critical;
Travel and booking platforms: Evaluation of booking agents that must handle cancellations, date changes, and policy compliance through dynamic, simulation-based scenarios; and
Multi-agent collaboration: Assessment of research assistants, planning frameworks, or cooperative AI systems where multiple agents exchange results, reconcile contradictions, and jointly achieve goals.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

We claim:

1. A system for evaluating Artificial Intelligence (AI) agents, the system comprising:
a data generation module configured to generate synthetic data based on a profile of the AI agent;
a simulation module configured to interact with the AI agent to generate traces, when the AI agent is interactive;
an evaluator module comprising a plurality of evaluator agents, wherein each of the plurality of evaluator agents is configured to generate an evaluation score based on the traces of the AI agent with respect to a corresponding evaluation metric; and
a report aggregation module configured to consolidate the evaluation scores of each of the plurality of evaluator agents to generate an evaluation report.

2. The system of claim 1, wherein the profile of the AI agent comprises one or more of a purpose of the AI agent, a domain of operation, a workflow description, and a set of tools accessible to the AI agent.

3. The system of claim 1, the data generation module, further comprises:
a scenario generation agent configured to generate a plurality of test scenarios based on the profile of the AI agent; and
a data generation agent configured to generate synthetic data for the plurality of generated test scenarios.

4. The system of claim 1, wherein the simulation module is configured to execute the AI agent to generate the traces based on the generated synthetic data, when the AI agent is not interactive.

5. The system of claim 1, wherein the simulation module, further comprises;
a planner agent configured to plan an interaction sequence with the AI agent based on the plurality of test scenarios; and
an interaction agent configured to execute the interaction sequence with the AI agent to generate the traces.

6. The system of claim 1, wherein the evaluator module is configured to evaluate reasoning accuracy, tool-calling efficiency, and outcome accuracy of the AI agent.

7. The system of claim 1, wherein the report aggregation module is configured to compute correlations among evaluation metric and the evaluation scores.

8. A method for evaluating Artificial Intelligence (AI) agents, the method comprising:
receiving a profile of the AI agent;
generating synthetic data based on the received profile of the AI agent;
interacting with the AI agent to generate traces, when the AI agent is interactive;
generating an evaluation score based on the traces of the AI agent with respect to a corresponding evaluation metric by a plurality of evaluator agents; and
generating an evaluation report by consolidating the evaluation scores of each of the plurality of evaluator agents.

9. The method of claim 8, wherein the profile of the AI agent comprises one or more of a purpose of the AI agent, a domain of operation, a workflow description, and a set of tools accessible to the AI agent.

10. The method of claim 8, wherein generating synthetic data based on the received profile of the AI agent, further comprising:
generating a plurality of test scenarios based on the profile of the AI agent; and
generate synthetic data for the plurality of generated test scenarios.

11. The method of claim 8, further comprising:
executing the AI agent to generate the traces based on the generated synthetic data, when the AI agent is not interactive.

12. The method of claim 8, wherein interacting with the AI agent to generate traces, further comprising:
planning an interaction sequence with the AI agent based on the plurality of test scenarios; and
executing the interaction sequence with the AI agent to generate the traces.

13. The method of claim 8, wherein generating an evaluation score based on the traces of the AI agent, further comprising:
evaluating reasoning accuracy, tool-calling efficiency, and outcome accuracy of the AI agent.

14. The method of claim 8, wherein generating an evaluation report, further comprising:
computing correlations among evaluation metric and the evaluation scores.

15. A non-transitory computer-readable storage medium having stored thereon computer executable instruction which when executed by one or more processors, cause the one or more processors to carry out operations for evaluating Artificial Intelligence (AI) agents, the operations comprising:
receiving a profile of the AI agent, wherein the profile of the AI agent comprises one or more of a purpose of the AI agent, a domain of operation, a workflow description, and a set of tools accessible to the AI agent;
generating synthetic data based on the received profile of the AI agent;
interacting with the AI agent to generate traces, when the AI agent is interactive;
generating an evaluation score based on the traces of the AI agent with respect to a corresponding evaluation metric by a plurality of evaluator agents; and
generating an evaluation report by consolidating the evaluation scores of each of the plurality of evaluator agents.

16. The operation of claim 15, wherein generating synthetic data based on the received profile of the AI agent, further comprising:
generating a plurality of test scenarios based on the profile of the AI agent; and
generate synthetic data for the plurality of generated test scenarios.

17. The operation of claim 15, further comprising:
executing the AI agent to generate the traces based on the generated synthetic data, when the AI agent is not interactive.

18. The operation of claim 15, wherein interacting with the AI agent to generate traces, further comprising:
planning an interaction sequence with the AI agent based on the plurality of test scenarios; and
executing the interaction sequence with the AI agent to generate the traces.

19. The operation of claim 15, wherein generating an evaluation score based on the traces of the AI agent, further comprising:
evaluating reasoning accuracy, tool-calling efficiency, and outcome accuracy of the AI agent.

20. The operation of claim 15, wherein generating an evaluation report, further comprising;
computing correlations among evaluation metric and the evaluation scores.
